(19) United States
(12) Patent Application Publication
(10) Pub. No.: US 2011/0225831 A1
(43) Pub. Date: Sep. 22, 2011

(54) Rotary Knife For Drywall and the Like

(76) Inventor: William T. Greenwood, Cedar, MI (US)

(21) Appl. No.: 12/726,075

(22) Filed: Mar. 17, 2010

(51) Int. Cl. B26B 25/00; B26B 11/00; B26B 29/06; B26B 5/00

(52) U.S. Cl. 30/293; 83/520; 83/522.11

(57) ABSTRACT

A utility knife with a replaceable circular blade mounted to rotate on the end of the handle. The upper half of the blade is shrouded by the end of the handle, and freely rotates therein. A spacer with a roller end is mounted to be adjusted toward and away from a workpiece to adjust and control the blade's depth of cut. The handle includes a storage compartment for spare blades and has a pivoting cover. For use as a drywall knife, the blade has a continuous edge and a thicker central body that presents discontinuous “points” or edge bodies to the workpiece along the sides of a the cut made by the continuous edge, designed to push apart the paper cover or sheath on the drywall as it makes a cut, and to keep the blade rolling freely as it makes a cut. A tape measure can optionally be incorporated into a rounded handle portion.

### RELATED APPLICATIONS/PRIORITY BENEFIT CLAIM

Not applicable.

### FIELD OF THE INVENTIVE SUBJECT MATTER

The subject matter of the present application is in the field of handheld utility knives of the type used for cutting drywall.

### BACKGROUND AND DESCRIPTION OF RELATED ART

Utility knives with short, thin blades that are disposable or replaceable are well known, and can be found in just about any handyman's toolbox or workbench. The blades are usually pointed and triangular, with a single straight edge, and often can be advanced from or retracted into the handle to adjust the amount of blade available and the depth of cut. The blades are of a thin and uniform thickness, unlike standard knife blades, so that they can be manufactured and replaced inexpensively. Utility knife blades are known for their thin profile and their corresponding sharpness, and are often used for cutting drywall. They require a pulling motion to cut (a “draw cut”).

It is also known to use rotary cutting disks for devices such as pizza and dough cutters. These are relatively thick and dull, are not precision cutting devices, and would not be suitable for use as utility knives. The cutting disks are fully exposed at the end of the handle, and have a fixed pivot connection to the handle so that the amount of blade available and the depth of cut cannot be varied.

### BRIEF SUMMARY OF THE INVENTIVE SUBJECT MATTER

I have invented a utility knife with a rotary blade, especially useful for cutting drywall and other materials requiring a thin, sharp blade. The blade is circular and connected to a handle with a fixed pivot connection to roll freely relative to the handle. The upper part of the blade is shrouded by a portion of the handle to protect the user's hand. Depth of cut is adjusted with a spacer associated with the blade that can be moved toward and away from a work-piece between the edge of the blade and its center of rotation, generally parallel to the blade, and then selectively secured in place at the desired distance. The spacer has a roller tip or surface that engages and rolls or slides smoothly over the face of the work-piece as the rotary blade makes a cut in the work-piece. “Roller” is used herein to include both rolling and sliding structures. The spacer may be external to or integrated with the handle.

The rotary blade can be permanent, or it can be replaceable, for example mounted to the handle with a removable screw or bolt that also adjustably secures the spacer arm.

In a further form, the rotary blade has a relatively thick body with a discontinuous interior body profile and a continuous circumferential edge. The thicker interior body has a circumference defining a series of scallops or edge bodies interrupted by points that help the blade “walk” or gain traction as it is pushed or pulled through a thick workpiece.

The handle optionally includes a circular storage compartment for storing spare blades. In the preferred form the storage compartment is located at the end of the handle opposite the rotary cutting end to define an enlarged “knob” or pommel that helps maintain a secure grip when making draw cuts. In yet a further preferred form, the forward portion of the handle that shrouds the upper part of the rotary blade defines an enlarged knob or guard for leverage and protection when making push cuts. The rotary blade of the knife allows both push and draw cuts to be made.

In yet a further form, the knife includes a device for measuring distance along the surface of the workpiece. In one form the measuring device is a tape measure device integrated with and retractable into the handle.

In yet a further form, the knife includes a device for aligning or guiding the knife along a cutting line. In one form, a laser type light is projected from the knife onto the work surface in front of the knife, in line with the rotary blade.

These and other features and advantages will become apparent from the detailed description below, in light of the accompanying drawings.

### BRIEF DESCRIPTION OF THE DRAWINGS

FIG. 1 is a side elevation view of a utility knife according to the invention, with the blade edge resting on a work-piece while a depth-limiting spacer or guide is adjusted.

FIG. 2 is similar to FIG. 1, but the blade has been inserted into the work-piece to bring the depth-limiting spacer into contact with the work-piece surface.

FIG. 3 is a perspective view of the utility knife of FIG. 1, showing a spare blade compartment open and a spare blade exploded from the compartment.

FIG. 4 is a side elevation view of an exemplary blade as shown in the knife of FIGS. 1 through 3.

FIG. 5 is an end view of the exemplary blade in FIG. 4.

FIG. 6 is a perspective view of the knife of FIG. 3, showing a laser alignment being projected from the knife onto the workpiece surface ahead of the direction of cut.

### DETAILED DESCRIPTION OF THE INVENTION

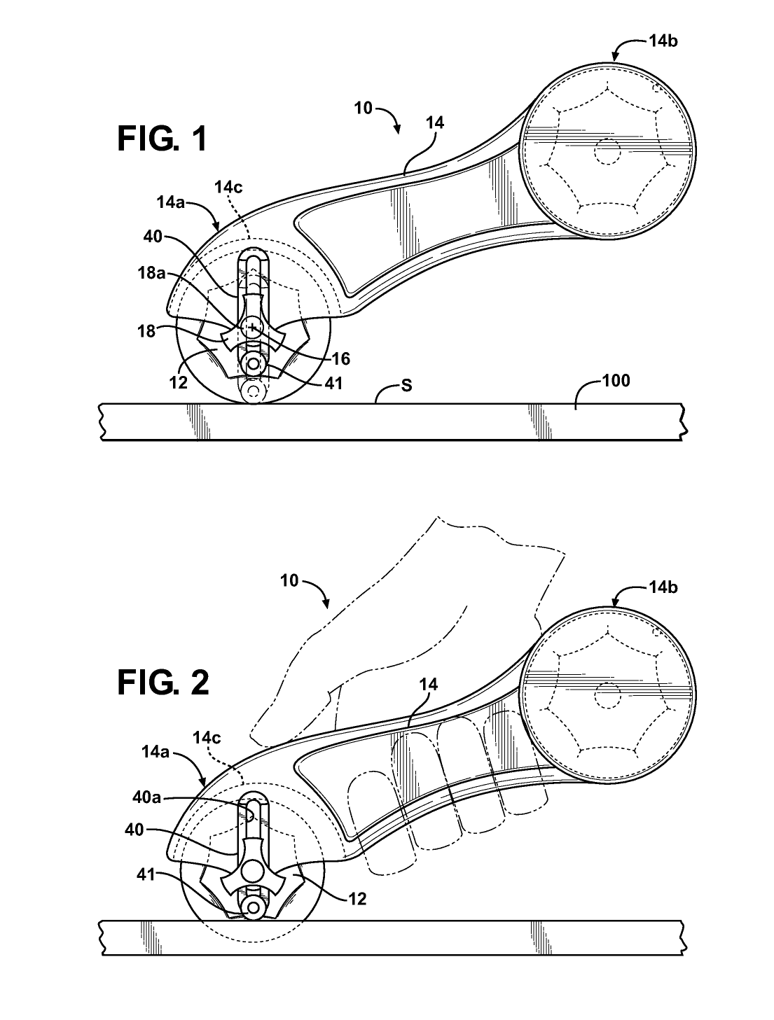

Referring first to FIG. 1, a rotary knife 10 is shown in exemplary form in order to teach how to make and use the claimed invention. Knife 10 is shown with its blade 12 resting on the surface of a work-piece 100, for example a piece of drywall. Work-piece 100 can be virtually anything that can be cut with a handheld utility knife blade, with a few examples including carpet, cardboard, drywall, and thin plastic materials.

Blade 12 is rotatably mounted on a “forward” end 14a of a handle 14. The main gripping portion of the handle between forward end 14a and rear end 14b preferably has a shape that makes it comfortable and secure in a user's hand. Rear end 14b is preferably enlarged, for example with a rounded wheel or pommel as illustrated, to improve grip when making a draw cut. Illustrated blade 12 is made from an appropriate metal such as steel, and illustrated handle 14 is made from an appropriate polymer or “plastic” material. Both blade 12 and handle 14 can vary in terms of the materials used, and are not limited to metal and plastic materials.

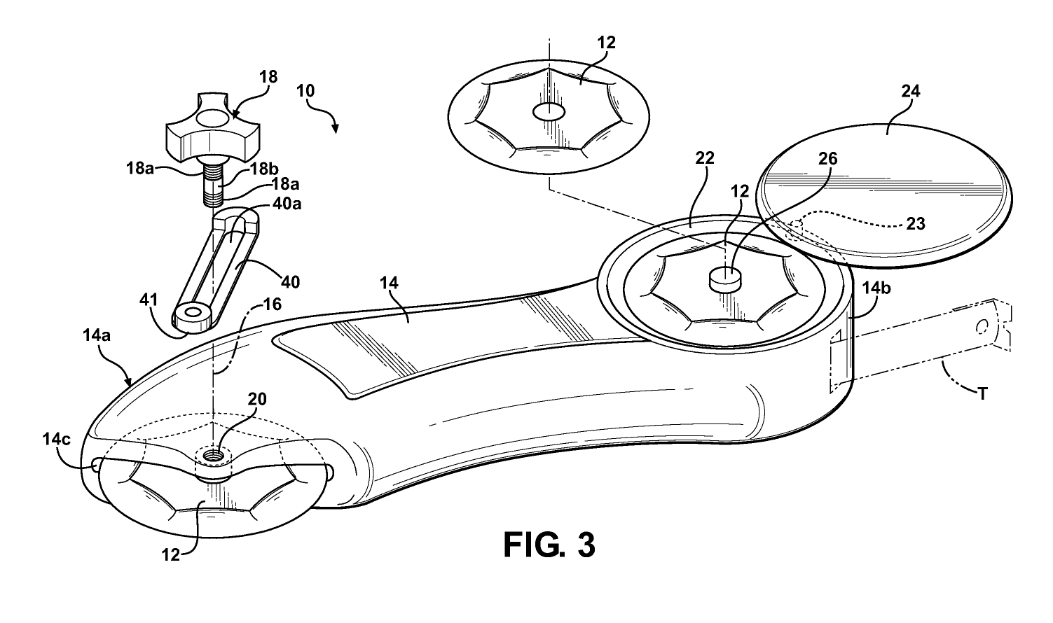

Blade 12 is mounted to rotate on an axis 16 generally perpendicular to the handle 14 at the forward end 14a of the handle. Pivot axis 16 can take various forms, in the illustrated embodiment including a removable shaft in the form of a thumbscrew 18 with a threaded shaft 18a securing the shaft in threaded holes or sockets 20 aligned with each other in the forward end of the handle, with a space between them for the blade to rotate. The illustrated shaft has a smooth portion 18b aligned with and engaged by the blade's hub 12a when the threaded portion(s) 18a is/are secured in the sockets 20 in forward end 14a of the knife 10 (shown in FIG. 3). The axis of rotation 16 for blade 12 is fixed, meaning it does not change location during cutting or during blade-depth adjustments described below. While a specific form of removable shaft 18 is illustrated for rotatably mounting the blade 12 on handle 14, allowing blade 12 to be removed for re-sharpening or replacement, other forms of removable shaft could be used, or a non-removable shaft mounting a non-removable blade 12 could also be used.

An upper part of blade 12 is shrouded in a hollow portion of forward end 14a of the handle, for example a generally hemispherical slot 14c molded or machined into forward end 14a with sufficient clearance to cover an upper portion (preferably the upper half) of blade 12 above axis 16 and to allow blade 12 to rotate. A person using knife 10 can accordingly place a hand above blade 12 when making a cut, for example if more control is desired; or, if a person's hand slips forwardly from a different part of the handle 14, the hand is protected from being cut on the upper portion of the blade 12. In the preferred form, as illustrated, the blade-shrouding forward end 14a swells upwardly from the main handle for added control and safety when making push cuts.

FIG. 3 shows an optional blade storage compartment 22 in the rear end 14b of the handle, with a removable cover 24 and a post 26 for securely stacking two or more spare blades 12 in the compartment. Cover 22 preferably opens and closes on an off-center pivot 23, although other opening and closing mechanisms are possible.

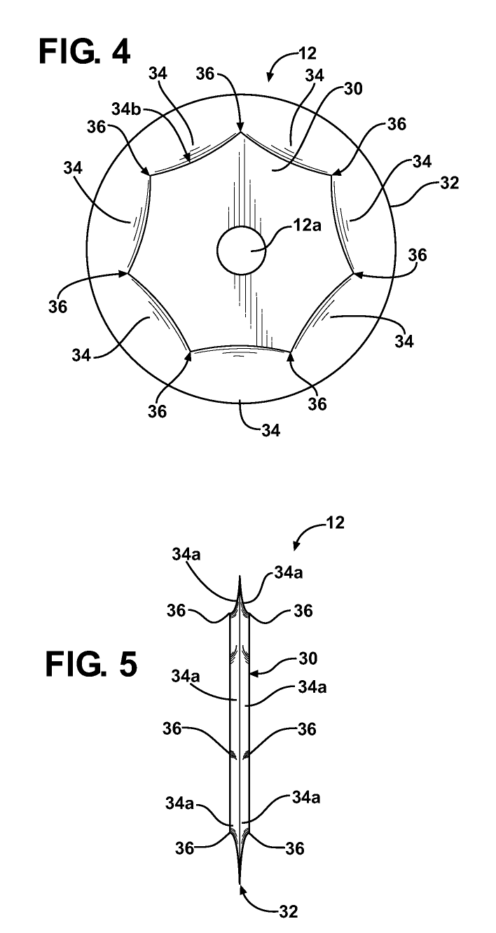

FIGS. 4 and 5 are detailed views of an exemplary and currently preferred blade 12, with an edge geometry designed especially for cutting tough materials such as drywall where at least the initial cut into the surface of the material should be a clean, precise cut. Blade 12 has a central body 30 and a circular edge 32, and a plurality of circumferential blade segments 34 formed as curved “scallops” ground or otherwise formed between body 30 and edge 32, the blade segments 34 separated by un-ground or thicker “points” 36 corresponding to the thickness of central body 30. Each blade segment 34 in the illustrated embodiment has a concave grind, with opposing surfaces 34a on opposite sides of the blade 12 that taper or curve inwardly in an arc to the edge 32 of the blade 12. The number of blade segments and their depth and dimensions and grind angle or curvature can vary. Points 36 may be literally pointed at their ends, or they may take rectangular or flattened forms at their tips as illustrated, depending on the angle or curvature or grind of blade segments 34. Blade segments 34 may be curved on their inner edges 34b, for example as shown with the illustrated “scallop” pattern, or they may have straight edges or have other inner edge geometries.

The relatively thin continuous edge 32 will make an initial precise cut into the workpiece 100, while the thicker “points” 36 of central body 30 will help force the cut workpiece material apart. Additionally, the points 36 will provide an interrupted frictional purchase on the workpiece material against the sides of the cut to help rotate blade 12 as the blade is pushed or pulled through the workpiece material, creating a more efficient cutting action.

Illustrated knife 10 includes a vertically adjustable spacer 40 associated with blade 12, adjustable toward and away from the exposed workpiece-contacting edge of the blade (and thus toward and away from the surface of workpiece 100) to limit the depth of the cut made with blade 12. In the illustrated example of FIG. 3, spacer 40 is a slotted elongated member adjustable up and down via slot 40a on a portion of the thumbscrew shaft 18a, adjacent and parallel to blade 12. Loosening the thumbscrew allows spacer 40 to be adjusted up or down; tightening the thumbscrew 18 locks the spacer 40 in place to maintain the desired cutting depth throughout the length of the cut, or to set a certain cut depth that can be maintained between different work-pieces or different parts of the same workpiece. The workpiece-contacting end of spacer 40 is preferably surfaced or provided with a glide or roller surface such as (but not limited to) roller 41 to ensure that it slides or rolls smoothly across the workpiece surface during a cut. Other possibilities include low-friction sliding surfaces on the end of the spacer 40.

It will be understood that while a linearly adjustable spacer 40 is illustrated, other spacer mechanisms are possible without being limited to a linearly adjustable elongated slotted member. By way of non-limiting example, a cam-type rotating adjustment for a non-linear spacer is believed to be possible. It will also be understood that various mechanisms may be used to adjust the spacer up and down and to selectively secure it in place, including but not limited to sliding friction mechanisms and click adjustment mechanisms. Spacer 40 may be located on the outside of handle 14, as illustrated, or partially retractable into a receptacle or chamber in handle 14.

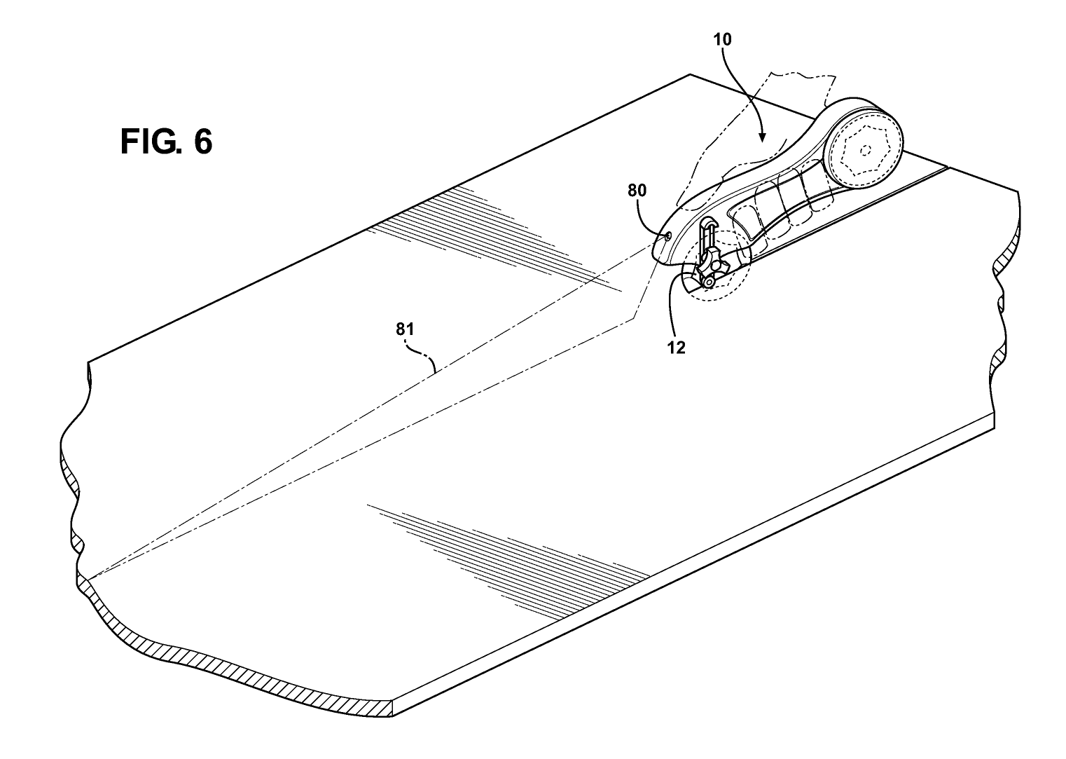

FIG. 6 shows an additional possible feature for knife 10, in the form of an optical line guide 80 capable of projecting an oscillating beam of light, for example a laser device of known type powered by a battery and capable of projecting a visible line or-dot (schematically illustrated at 81 in FIG. 6) forward of the knife 10 and aligned with the plane of blade 12 to provide an advance indicator of cutting direction.

FIG. 3 also shows an optional tape measure T integrated into the handle 14, for example wound or scrolled around an interior spool molded into the handle in the vicinity of the blade storage compartment 22 on the rear end of the handle.

In operation, spacer 40 is set at the desired position with thumbscrew 18 (FIG. 1) to limit how much of the lower half of blade 12 can penetrate into workpiece 100 before roller 41 engages the surface S of the workpiece (FIG. 2). Knife 10 can then be pushed or pulled through the workpiece 100 to make a cut. The depth of cut can be adjusted simply by adjusting spacer 40 up or down using the thumbscrew 18.

It will finally be understood that the disclosed embodiments are representative of presently preferred forms of the invention, but are intended to be explanatory rather than limiting of the invention. Reasonable variations and modifications of the invention as disclosed in the foregoing written specification and drawings are possible without departing from the scope of the invention as defined in the claims. It should further be understood that the use of the term “invention” in this written specification is not to be construed as a limiting term as to number or scope, but as a descriptive term which has been used conveniently to describe advances in technology for many years. The scope of the invention is accordingly defined by the following claims.

What is claimed:

1. A cutting device, comprising:
a handle;
a circular blade mounted to rotate on an end of the handle, an upper part of the blade shrouded by the end of the handle;
a spacer mounted on the handle adjacent and generally parallel to the blade, the spacer having a roller surface on a distal end, the spacer movable toward and away from an exposed edge of the blade and selectively securable in different positions to adjust a spacing of the roller surface from the exposed edge of the blade to limit a depth of cut of the blade into the workpiece.

2. The cutting device of claim 1, wherein the blade comprises a continuous edge and an interior body spaced from the continuous edge, the interior body defining blade segments separated by points having a thickness greater than the blade segments.

3. The cutting device of claim 2, wherein the interior body of said blade is of greater thickness than the continuous edge.

4. The cutting device of claim 1, wherein the blade is removable and replaceable on the handle.

5. The cutting device of claim 4, wherein the handle comprises shrouded storage for a replacement blade.

6. The cutting device of claim 5, wherein the shrouded storage comprises a replacement blade storage compartment on a second end of the handle opposite the blade end.

7. The cutting device of claim 6, wherein the replacement blade storage compartment comprises a cover.

8. The cutting device of claim 7, wherein the circular cover is connected to the handle by an off-center pivot so that the cover rotates away from a compartment-covering position to a blade-access position.

9. The cutting device of claim 1, further comprising a light-projecting device for projecting a visible indicator forwardly of the knife onto a workpiece in alignment with the blade.

10. The cutting device of claim 1, further comprising a tape measure incorporated into the handle.
